(19) United States
(12) Patent Application Publication
(10) Pub. No.: US 2017/0128162 A1
(43) Pub. Date: May 11, 2017

(54) ORTHODONTIC APPARATUS

(71) Applicant: Diego Dalla-Bona, Fort Lauderdale, FL (US)

(72) Inventor: Diego Dalla-Bona, Fort Lauderdale, FL (US)

(21) Appl. No.: 15/295,766

(22) Filed: Oct. 17, 2016

Related U.S. Application Data
(60) Provisional application No. 62/242,843, filed on Oct. 16, 2015.

(51) Int. Cl. A61C 7/10; A61C 7/00; A61C 7/08

(52) U.S. Cl. CPC A61C 7/10; A61C 7/08; A61C 7/002

(57) ABSTRACT

The present disclosure generally relates to an orthodontic apparatus comprising an appliance body that has a plurality of mechanisms and a supporting cover that is molded based on a patient's teeth positions; and an adjustment base that has a plurality of motors, a plurality of coupling units, a power supply and a processing unit. The adjustment base provides adjustment forces to the plurality of mechanisms through the plurality of motors and the plurality of coupling units when the appliance body is coupled to the adjustment base. The appliance body is then worn by the patient for teeth repositioning where each of the plurality of mechanisms will provide a pushing or pulling force to at least one tooth of the patient.

### CROSS-REFERENCE TO RELATED PATENT APPLICATIONS

Embodiments of the present invention relate to U.S. Provisional Application Ser. No. 62/242,843, filed Oct. 16, 2015, entitled “ORTHODONTIC APPARATUS,” the contents of which are incorporated by reference herein in their entirety and which are a basis for a claim of priority.

### FIELD OF THE INVENTION

Embodiments of the present disclosure generally relate to an orthodontic apparatus for tooth positioning. Specifically, the present disclosure discloses an improved orthodontic apparatus allowing orthodontists to provide more accurate tooth adjustments by applying force to the teeth with greater precision (in terms of both the amount and the direction of the force), thereby allowing for more precise tooth movement and improving the proper orientation of teeth. Additionally, the disclosed apparatus is almost invisible, removable, and more comfortable and versatile than existing treatment methods. Finally, the apparatus may include sensors and other smart technologies to allow the orthodontist to monitor tooth movement and modify the treatment plan as necessary.

### BACKGROUND

Orthodontic treatment involves correcting malocclusion, which is the misalignment of a bite or incorrect spacing between teeth, or correcting any tooth position for aesthetic purposes. This is usually accomplished through the use of orthodontic braces or, more recently, a series of clear aligners.

When a person seeks to correct the positioning of his or her teeth (for either functional or aesthetic reasons), he or she must first undergo a consultation that involves an initial examination, discussion of dental history and review of X-rays of the teeth and mouth. This helps the orthodontist to determine whether the tooth movement will help improve bite or tooth position for better function or aesthetics. The traditional corrective option is dental braces (facial or lingual). If dental braces are used, regular adjustments are necessary. Without adjustments, the wires would be incapable of creating the proper pressure to correct the dental issues requiring treatment.

During adjustment, the orthodontist evaluates the movement of the person's teeth and the progress made. This allows for recommendations that may improve the final outcome of the treatment plan. The orthodontist also checks treatment progress and recommends new wires and bands. New wires and elastics are then placed to continue moving the teeth and proceed with treatment.

However, under such a conventional method, the amount of force applied to move the teeth cannot be precisely calibrated, thereby increasing the risk of damage to periodontal tissues. Furthermore, if tooth movements are inaccurate, a person's time wearing the braces might be increased. In addition, many patients believe that facial braces are not aesthetically pleasing, and lingual braces can cause damage to soft tissues and make oral hygiene difficult.

In addition, the braces currently used are painful and interfere with many aspects of a wearer's daily life. The braces are unsightly and cannot be removed when eating, brushing or during social interactions. Often people avoid having their teeth fixed because of the pain, discomfort, burden and appearance of typical braces. Mouthpiece-type aligning systems, such as clear aligners, have been an improvement in this, but such mouthpieces are limited to fixing only a small portion of dental alignment problems and can only improve tooth orientation along a single horizontal-type axis. Clear aligners cannot improve tooth leveling (vertical axis), torque, or bodily movement. Furthermore, in most cases several aligners (more than 30) are needed in order to accomplish the desired results.

Accordingly, there exists a need to provide an orthodontic apparatus that can improve alignment, leveling, torque and bodily movement of the teeth along more than one axis; that may be removable; will allow better oral hygiene; is not readily visible; will apply force precisely, in the proper direction, without hurting periodontal tissues around teeth; and that may reduce treatment time and patient discomfort.

### SUMMARY OF THE DISCLOSURE

The major objective of the present disclosure is to provide an orthodontic apparatus that improves the alignment, leveling, torque and bodily movement of the teeth along more than one axis during repositioning.

Another objective of the present disclosure is to provide an orthodontic apparatus that is removable by the patient when eating, brushing or during social interactions, thereby reducing patients' discomfort and preventing the periodontal tissues around patients' teeth from being damaged.

Another objective of the present disclosure is to provide an orthodontic apparatus that may reduce treatment time by using sensors to monitor the movement of the teeth.

Accordingly, the present invention provides methods and automated systems for repositioning teeth from an initial position to a final position. The reposition movement is done using one or more progressive appliances, which are adjusted automatically, providing great position and strength accuracy applied to each tooth, thereby promoting a fine gradual movement that contributes to a more efficient treatment requiring less time and/or discomfort to the patient.

In accordance with one aspect of at least one embodiment of the present disclosure, the orthodontic apparatus comprises: 1) an appliance body that has a plurality of mechanisms and a supporting cover that is molded based on a patient's teeth positions, and 2) an adjustment base that has a plurality of motors, a plurality of coupling units, a power supply and a processing unit. The adjustment base provides adjustment forces to the plurality of mechanisms through the plurality of motors and the plurality of coupling units when the appliance body is coupled to the adjustment base. The appliance body is then worn by the patient for teeth repositioning where each of the plurality of mechanisms will provide a pushing or pulling force to at least one tooth of the patient.

The treatment plan includes several steps that will be gradually and automatically applied using the adjustment base outside the patient's mouth, following the guidelines selected by a dentist. The number of steps will vary depending on each case and the final result expected by the patient. Frequently the number of steps will be between 15-20 steps for non-complex cases, and 40 or more for complex cases or cases involving all the teeth.

The present invention also allows the individual adjustment of the tooth position and strength applied on each tooth. This adjustment will be made by the precise movement of screw shafts and/or actuators and/or cables and/or tensioners that will guide each tooth precisely to the final position, based on the resulting force. The movements of those parts are executed by turning the corresponding screw socket causing the part to move towards or against the teeth. Each appliance will be made from polymeric and/or metallic and/or ceramic pieces, which will be molded and positioned based on the initial mold made from the patient's teeth.

Based on the method of the present invention, the teeth will be moved from an initial position to a final position by a series of steps. Conveniently the appliance can be removed from the mouth and inserted again anytime. The treatment plan can be conveniently adjusted to be more light or hard, based on patient request. Usually the transition to the next treatment step can be based on many factors; normally the transition is time based, on a fixed schedule defined by the dentist or based on the patient's response to the treatment, which the dentist can evaluate and adjust.

In general, the methods of the present invention comprehend the tooth repositioning by using appliances made of polymeric resins, ceramic and metals, all of them molded to the patient's mouth. The present invention improves upon the typical teeth repositioning methods because it uses a precise number of steps that will be automatically applied to the patient appliance without the need to visit the dentist. Furthermore, the steps can be adjusted anytime, without the need of new appliances at each step.

The foregoing and other objects, features and advantages of the present invention are more readily apparent from the detailed description of the preferred embodiments set forth below, taken in conjunction with the accompanying drawings.

### BRIEF DESCRIPTION OF THE DRAWINGS

FIG. 1 is a schematic drawing according to an exemplary embodiment of the present invention.

FIG. 2 is a schematic drawing according to an exemplary embodiment of the present invention.

FIG. 3 is a schematic drawing according to an exemplary embodiment of the present invention.

FIG. 4 is a schematic drawing according to an exemplary embodiment of the present invention.

FIG. 5 is a schematic drawing according to an exemplary embodiment of the present invention.

FIG. 6 is a schematic drawing according to an exemplary embodiment of the present invention.

FIG. 7 is a schematic drawing according to an exemplary embodiment of the present invention.

### DETAILED DESCRIPTION OF PREFERRED EMBODIMENTS

The following description is not to be taken in a limiting sense, but is made merely for the purpose of illustrating the general principles of the invention, since the scope of the invention is best defined by the following claims. Various inventive features are described below that can each be used independently of one another or in combination with other features.

Broadly, embodiments of the present disclosure generally provide an orthodontic apparatus that provides more accurate tooth adjustments by applying force to the teeth with greater precision (in terms of both the amount and the direction of the force), thereby allowing for more precise tooth movement and improving the proper orientation of teeth.

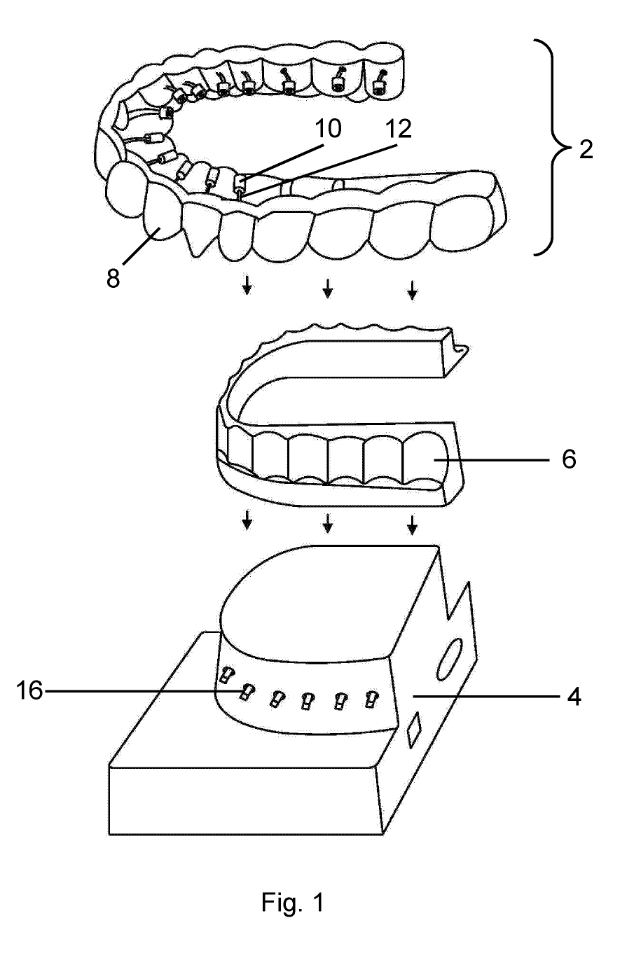

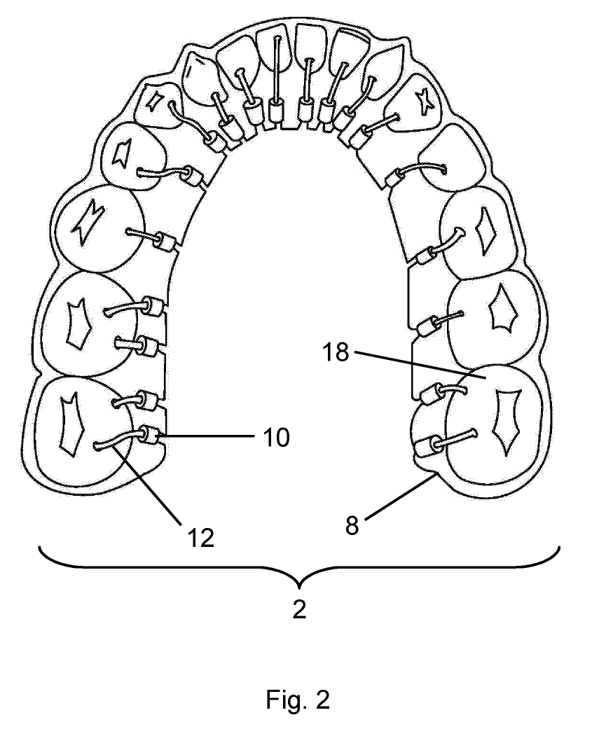

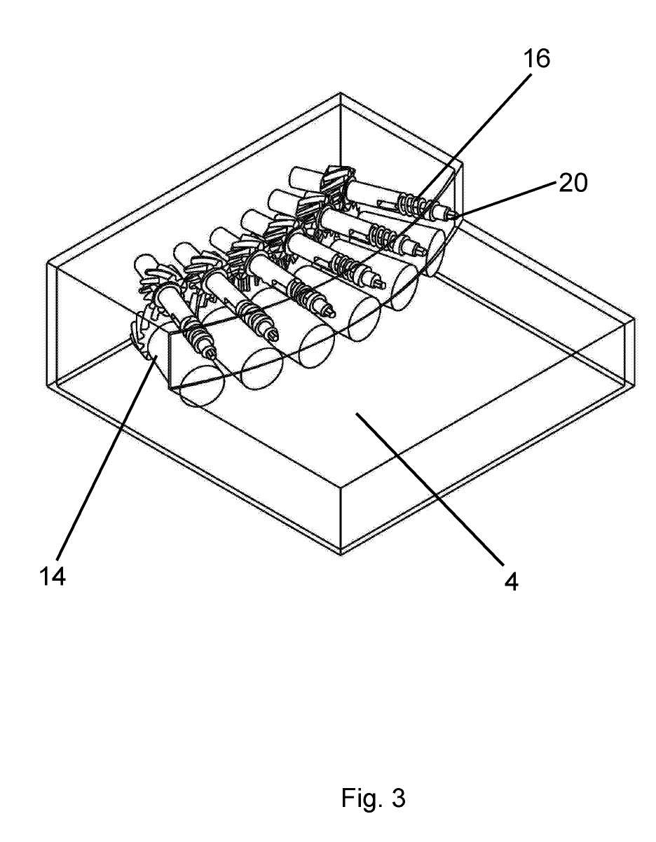

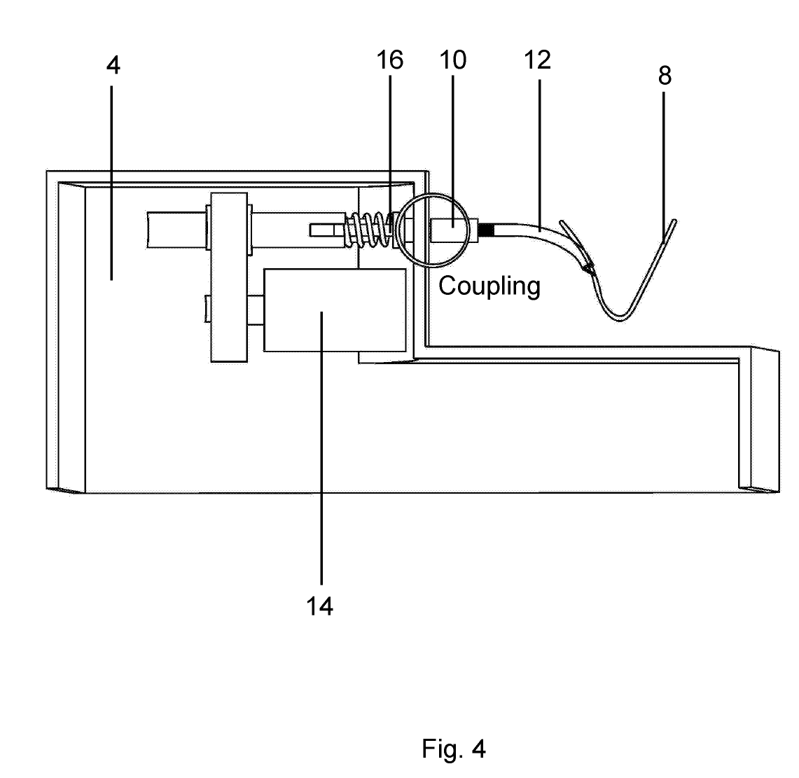

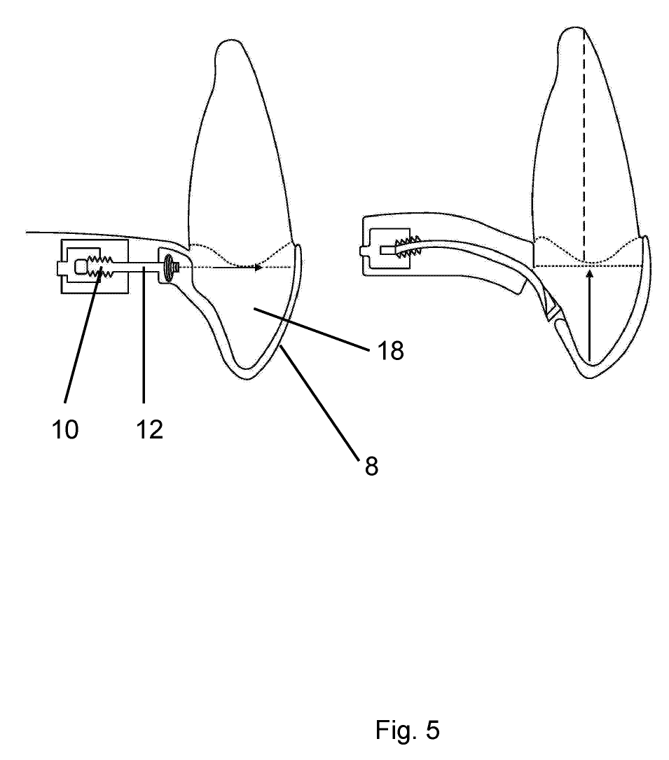

In accordance with one aspect of at least one embodiment of the present disclosure, as shown by FIG. 1, the disclosed orthodontic apparatus primarily comprises an appliance body 2 and an adjustment base 4. The appliance body 2, as shown by FIG. 2, further comprises a plurality of mechanisms (10 and 12) and a supporting cover 8 (or tooth housing) that is molded based on a patient's teeth positions. The adjustment base, as shown by FIGS. 3 and 4, further comprises a plurality of motors 14, a plurality of coupling units 16, a power supply and a processing unit. The adjustment base 4 provides adjustment forces to the plurality of mechanisms (10 and 12) through the plurality of motors 14 and the plurality of coupling units 16 when the appliance body 8 is coupled to the adjustment base 4. The appliance body 2 is then worn by the patient for teeth repositioning where each of the plurality of mechanisms (10 and 12) will provide a pushing or pulling force to at least one tooth of the patient as shown by FIG. 5. The supporting cover 8 can be made of plastic and/or stainless steel, and configured in a way that it holds all the plurality of mechanisms (10 and 12). The source of power supply of the adjustment base 4 can come from a battery, a rechargeable battery, an external power source, or a combination thereof.

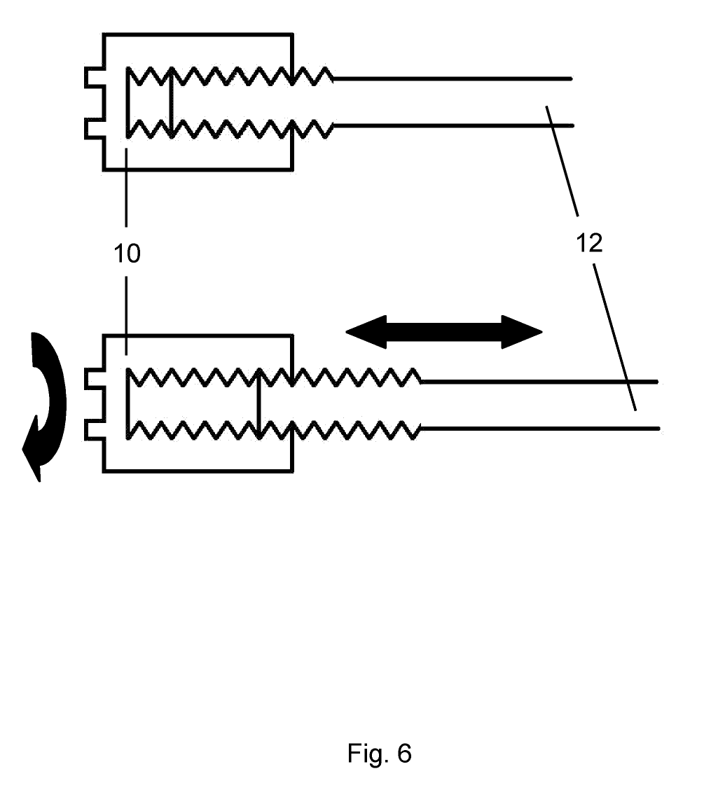

In one embodiment of the present disclosure, as shown by FIGS. 1 and 2, each of the plurality of mechanisms is formed by an adjustment screw 10 and an actuator 12. As shown by FIG. 6, the adjustment screw 10 and the actuator 12 are configured in a way that when the adjustment screw 10 is being turned or rotated, the actuator 12 will either be pushed away or pulled toward the adjustment screw 10, thereby providing a pushing or pulling force to a patient's tooth. Although the mechanism here has been described with reference to a particular embodiment, this description is not meant to be construed in a limiting sense. Various modifications of the disclosed embodiments as well as alternative embodiments of the invention will become apparent to persons skilled in the art. It is therefore contemplated that the design covers any mechanisms or combinations of mechanisms that is capable of producing the same function. Preferably, the actuator 12 is made of a flexible material and it can be specified for each patient depending on each patient's needs. For instance, the actuator 12 can be made of plastic, stainless steel (e.g., a spring), resin or a combination thereof. The adjustment screws 10 can be made from stainless steel or hard plastics as well. Preferably, the adjustment screws 10 will have fixed positions for all patients so that same adjustment base 4 can be used for all appliance bodies 2 from different patients.

In yet another embodiment of the present disclosure, as shown by FIG. 5, the actuators 12 can be designed in a way that they either directly contact the patient's teeth 18, or indirectly through the supporting cover 8 (e.g., the actuator 12 pushes/pulls the supporting cover 8 and the supporting cover 8 pushes/pulls patient's teeth, etc.) or an additional cover for teeth 18.

In yet another embodiment of the present disclosure, as shown by FIGS. 3 and 4, the plurality of coupling units 16 are designed like spring loaded bits where each bit 20 is locked into a corresponding adjustment screw 10 when the appliance body 2 is coupled to the adjustment base 4. Thus when the motors 14 turn the bits 20, the bits 20 turns the adjustment screws 10 and allow the actuators 12 to provide pushing or pulling force with respect to the teeth.

In yet another embodiment of the present disclosure, the plurality of coupling units 16 may further comprise sensor(s) that monitor the rotation or movement of coupling units 16 (or adjustment screws 10). The sensors provide feedback of how much each bit 20 turned, therefore the position of each actuator 12 and the proportional force applied can be known. The sensors can be located anywhere inside the adjustment base 4 (e.g., any part of the gearbox or at the motor shaft etc.). Thus, sensors allow orthodontists to precisely define the tooth's final position and the force applied to the same, then all those parameters can be defined by the orthodontists during the setup of the treatment plan, and redefined anytime based on any factor, such as patient comfort. For example, the rotation of coupling units 16 or adjustment screws 10 can be monitored using sensors like optical encoders attached to each bit 20. Once all actuators 12 are repositioned the appliance body 2 can be removed from the adjustment base 4 and used normally by the patient.

In yet another embodiment of the present disclosure, the processor within the adjustment base allows an orthodontist (or a user with permission) to use a computer, a tablet or a smart phone to select the amount of adjustment force to apply to each of the plurality of mechanisms (10 and 12). For example, to make the usage of the adjustment base 4 simple, the processor can be programmed in a way that allows the orthodontist to select a patient program using a computer, or a smartphone, before the appliance body 2 can be fitted on the adjustment base 4. Preferably, to avoid mistakes, the appliance body 2 and the adjustment base 4 should be designed in a way that there is only one way to fit the appliance body 2 into the adjustment base 4. Once fitted in the adjustment base 4 each spring loaded bit 20 (or coupling unit 16) will lock in the corresponding screw socket 10. The adjustment base 4 will define, based on the patient program, the required displacement of each actuator 12, then it will translate the displacement to angle of rotation to be applied to each screw socket 10; the motors 14 are then activated to precisely execute the computed movement. The processor can be communicated with by phone, tablet or computer through a wired cable, or wirelessly using standard wireless technology.

In yet another embodiment of the disclosure, the disclosed orthodontic apparatus further comprises an adjustment interface 6 that can be made of a ductile material such as rubber and plastic. The shape on one side of the adjustment interface 6 is formed based on the shape of the appliance body (i.e., the patient's teeth). The purpose of the adjustment interface 6 is to ease and secure the fit between the appliance body 2 and the adjustment base 4. Further, since each patient's tooth position may be different, the adjustment interface 6 allows an adjustment base 4 to be used on different appliance bodies 2 from different patients, thereby eliminating the need to customize the adjustment base for each patient.

In summary, systems and methods of the present disclosure are provided to incrementally move patient teeth by successive small displacements; the movements are the same as are associated with typical orthodontics treatment, including translation and rotation in all axes to reproduce the already known movements of tipping, translation, rotation, extrusion, intrusion and torqueing, individually or in any combination. The appliance body 2 of the present disclosure can be made of metallic, ceramic and/or polymeric pieces; those pieces will be attached to the adjustment base 4 and adjusted gradually during the treatment until the teeth reach their final position. The teeth movement can be determined by many factors, such as the positioning of each actuator 12, the force applied by the actuator 12, the presence or not of some resin attached to the teeth, and the force applied by the teeth mold; the sum of all such factors generate the resulting force which will guide the teeth to their final position. Additionally, the appliance body 2 can be designed to be almost invisible and made from transparent plastic like Invisalign®, positioned in the palatal region, and removable by the patient at any time. The adjustment base 4 is responsible for the repositioning of the elements in the appliance body 2, providing the treatment progression. Using motors 14, actuators 12, sensors and if needed the adjustment interface 6, the adjustment base 4 automatically changes the physical configuration of the appliance body 2 to move the teeth gradually to their final position. The adjustment interface 6, when needed, is produced with the adjustment base 4, and serves as an interface between the appliance body 2 and the adjustment base 4. The need of this adjustment interface 6 is based on the patient teeth position before the treatment.

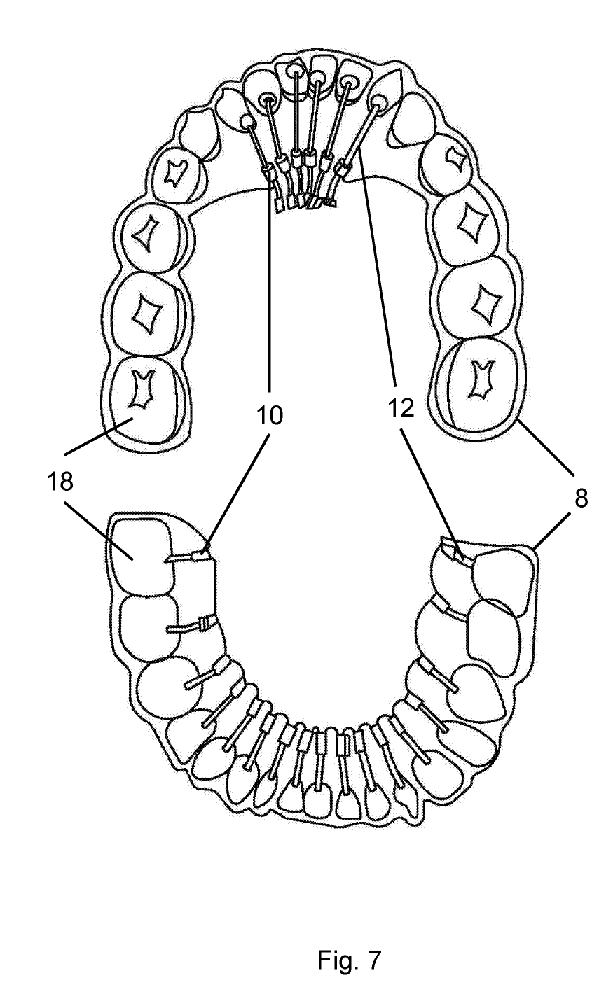

FIG. 7 is another exemplary embodiment showing appliance body 2 for both top and bottom teeth. Note the adjustment base 4 can be designed in a way that both appliance bodies 2 for top and bottom teeth use the same adjustment base 4. It can also be designed in a way that the adjustment base of the top teeth's appliance body is different from that of the bottom teeth so two different adjustment bases will be required.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. An orthodontic apparatus comprising:
an appliance body comprising a plurality of mechanisms and a supporting cover that is molded based on a patient's teeth positions;
an adjustment base comprising a plurality of motors, a plurality of coupling units, a power supply and a processing unit;
wherein the adjustment base provides adjustment forces to the plurality of mechanisms through the plurality of motors and the plurality of coupling units when the appliance body is coupled to the adjustment base; and
wherein the appliance body is to be worn by the patient for teeth repositioning where each of the plurality of mechanisms provides a pushing or pulling force to at least one tooth of the patient.

2. The orthodontic apparatus of claim 1, wherein each of the plurality of mechanisms comprises an adjustment screw and an actuator.

3. The orthodontic apparatus of claim 2, wherein the adjustment screw causes the actuator to move towards or against a tooth when the adjustment screw is being turned, thereby creating the pushing or pulling force.

4. The orthodontic apparatus of claim 2, wherein the actuator is made of plastic, stainless steel, resin or a combination thereof.

5. The orthodontic apparatus of claim 2, wherein the actuator either directly contacts at least one tooth of the patient, or indirectly through the supporting cover or an additional cover.

6. The orthodontic apparatus of claim 1, wherein the supporting cover is made of plastic and holds all the plurality of mechanisms.

7. The orthodontic apparatus of claim 1 further comprises an adjustment interface made of ductile material, wherein the appliance body is coupled to the adjustment base through the adjustment interface.

8. The orthodontic apparatus of claim 1, wherein the power supply is a battery, a rechargeable battery, an external power source, or a combination thereof.

9. The orthodontic apparatus of claim 1, wherein each of the plurality of coupling units comprises a spring loaded bit that is locked into a corresponding mechanism when the appliance body is coupled to the adjustment base.

10. The orthodontic apparatus of claim 1, wherein each of the plurality of coupling units further comprises a sensor that monitors each of the plurality of coupling units' rotations.

11. The orthodontic apparatus of claim 1, wherein the processor allows a user to use a computer, a tablet or a smart phone to select amount of adjustment force to apply to each of the plurality of mechanisms.

12. An orthodontic apparatus comprising:
an appliance body comprising a plurality of adjustment screws, a plurality of actuators and a supporting cover that is molded based on a patient's teeth positions;
an adjustment base comprising a plurality of motors, a plurality of spring loaded bits, a power supply and a processing unit;
wherein each of the plurality of adjustment screws is coupled to an actuator and causes the actuator to move towards or against a tooth of the patient when the adjustment screw is being turned;
wherein the plurality of motors provides turning forces to the plurality of adjustment screws through the plurality of spring loaded bits when the appliance body is coupled to the adjustment base where each spring loaded bit is coupled to a corresponding adjustment screw; and
wherein the appliance body is to be worn by the patient for teeth repositioning after the plurality of actuators are being shifted to their desired positions by the adjustment base.

13. The orthodontic apparatus of claim 12, wherein the plurality of actuators is made of plastic, stainless steel, resin or a combination thereof.

14. The orthodontic apparatus of claim 12, wherein each of the plurality of actuators either directly contacts a tooth of the patient, or indirectly through the supporting cover or an additional cover.

15. The orthodontic apparatus of claim 12 further comprises an adjustment interface made of ductile material, wherein the appliance body is coupled to the adjustment base through the adjustment interface.

16. The orthodontic apparatus of claim 12, wherein the power supply is a battery, a rechargeable battery, an external power source, or a combination thereof.

17. The orthodontic apparatus of claim 12, wherein each of the plurality of spring loaded bits further comprises a sensor that monitors each spring loaded bit's rotation to ensure precise turning of the adjustment screw.

18. The orthodontic apparatus of claim 12, wherein the processor allows a user to use a computer, a tablet or a smart phone to select a program that determines number of turnings to apply to each of the plurality of adjustment screws by the plurality of motors in the adjustment base.

19. An orthodontic apparatus comprising:
an appliance body comprising a plurality of adjustment screws, a plurality of actuators and a plastic supporting cover that is molded based on a patient's teeth positions;
an adjustment interface made of ductile material;
an adjustment base comprising a plurality of motors, a plurality of spring loaded bits, a power supply and a processing unit;
wherein each of the plurality of adjustment screws is coupled to an actuator and causes the actuator to move towards or against a tooth of the patient when the adjustment screw is being turned;
wherein the plurality of motors provides turning forces to the plurality of adjustment screws through the plurality of spring loaded bits when the appliance body is coupled to the adjustment base where each spring loaded bit is coupled to a corresponding adjustment screw;
wherein the appliance body is coupled to the adjustment base through the adjustment interface;
wherein each of the plurality of spring loaded bits further comprises a sensor that monitors each spring loaded bit's rotation to ensure precise turning of the adjustment screw; and
wherein the appliance body is to be worn by the patient for teeth repositioning after the plurality of actuators are being shifted to their desired positions by the adjustment base, where each of the plurality of actuators either directly contacts the tooth of the patient, or indirectly through the supporting cover or an additional cover.

20. The orthodontic apparatus of claim 19, wherein the sensor is an optical encoder.
